(19) United States
(12) Patent Application Publication
(10) Pub. No.: US 2024/0410379 A1
(43) Pub. Date: Dec. 12, 2024

(54) VACUUM PUMP, VACUUM PUMP BEARING PROTECTION STRUCTURE, AND VACUUM PUMP ROTATING BODY

(71) Applicant: Edwards Japan Limited, Chiba (JP)

(72) Inventor: Toshiki Yamaguchi, Chiba (JP)

(21) Appl. No.: 18/699,779

(22) PCT Filed: Nov. 9, 2022
(86) PCT No.: PCT/JP2022/041792

§ 371 Date: Apr. 9, 2024

(30) Foreign Application Priority Data
Nov. 16, 2021 (JP) 2021-186398

(51) Int. Cl. F04D 19/04; F04D 29/056

(52) U.S. Cl. CPC F04D 19/042; F04D 19/048; F04D 29/056

(57) ABSTRACT

A vacuum pump includes a rotating body including a rotor blade; a rotor shaft disposed in a center of the rotating body; a magnetic bearing configured to levitate and support the rotor shaft; a touchdown bearing that is separated, by a gap, from the rotor shaft and configured to support the rotor shaft when the magnetic bearing is uncontrollable; and a bearing protection structure configured to protect the touchdown bearing. The bearing protection structure includes a protrusion disposed on at least one of the rotating body and a component around the rotating body. Upon a touchdown of the rotor shaft on the touchdown bearing, the rotating body comes into contact with the component around the rotating body through the protrusion so that kinetic energy of the rotating body acting on the touchdown bearing is reduced.

### CROSS-REFERENCE TO RELATED APPLICATION

This application is a Section 371 National Stage Application of International Application No. PCT/JP2022/041792, filed Nov. 9, 2022, which is incorporated by reference in its entirety and published as WO 2023/090231A1 on May 25, 2023 and which claims priority of Japanese Application No. 2021-186398, filed Nov. 16, 2021.

### FIELD

The present invention relates to a vacuum pump, a vacuum pump bearing protection structure, and a vacuum pump rotating body.

### BACKGROUND

A common vacuum pump, typified by a turbomolecular pump for example, has a rotating body including, in a center thereof, a rotating shaft supported by a magnetic bearing. When the magnetic bearing becomes uncontrollable due to a power failure or the like, the rotating shaft rotating at high speed would come into direct contact with the magnetic bearing and thus damage the vacuum pump. To prevent this, a touchdown bearing is.

The discussion above is merely provided for general background information and is not intended to be used as an aid in determining the scope of the claimed subject matter. The claimed subject matter is not limited to implementations that solve any or all disadvantages noted in the background.

### SUMMARY OF INVENTION

In recent years, an increase in size accompanying an increase in pump load, and the change of materials to enhance heat-resistant materials resulting from high-temperature requirements have increased a rotating body weight. This has accordingly increased kinetic energy of the rotating body that is applied to the touchdown bearing (protective bearing) when the magnetic bearing becomes uncontrollable. One technique to accommodate greater kinetic energy is to increase the size of the touchdown bearing. However, a larger size of the touchdown bearing increases the overall size of the vacuum pump. This is not preferable in terms of design.

In view of the foregoing, it is an object of the present invention to provide a vacuum pump, a vacuum pump bearing protection structure, and a vacuum pump rotating body that can reduce kinetic energy of a rotating body acting on a touchdown bearing when a magnetic bearing is uncontrollable.

To achieve the above object, an aspect of the present invention relates to a vacuum pump including: a rotating body including a rotor blade; a rotor shaft disposed in a center of the rotating body; a magnetic bearing configured to levitate and support the rotor shaft; a touchdown bearing that is separated, by a gap, from the rotor shaft and configured to support the rotor shaft when the magnetic bearing is uncontrollable; and a bearing protection structure configured to protect the touchdown bearing, wherein the bearing protection structure includes a protrusion disposed on at least one of the rotating body and a component around the rotating body, and upon touchdown of the rotor shaft on the touchdown bearing, the rotating body comes into contact with the component around the rotating body through the protrusion so that kinetic energy of the rotating body acting on the touchdown bearing is reduced.

The above configuration preferably includes a stator column serving as the component around the rotating body and disposed at an inner circumference side of the rotating body and at an outer circumference side of the rotor shaft, and the protrusion is disposed on at least one of an inner circumference surface of the rotating body or an outer circumference surface of the stator column.

In the above configuration, a purge gas flow passage, through which purge gas flows, is preferably formed between the inner circumference surface of the rotating body and the outer circumference surface of the stator column, and the protrusion is preferably disposed in the purge gas flow passage.

The above configuration preferably includes at a back side of the rotating body a back plate that is disposed as the component around the rotating body or a part of the component to prevent disturbance of exhaust gas, and the protrusion is preferably disposed on at least one of a back surface of the rotating body and the back plate.

The above configuration preferably includes a storage portion that is disposed at a position downstream of the protrusion to store contaminants created on contact between the rotating body and the component around the rotating body.

In the above configuration, the protrusion is preferably disposed to be adjacent to a downstream end of the rotating body.

In the above configuration, the protrusion is preferably provided in plurality, and the plurality of protrusions are preferably arranged at regular intervals in a circumferential direction.

In the above configuration, the protrusion preferably has a surface that has a lower friction property than those of the rotating body and the component around the rotating body.

To achieve the above object, another aspect of the present invention relates to a vacuum pump bearing protection structure to be used in a vacuum pump to protect a touchdown bearing, wherein the vacuum pump includes: a rotating body including a rotor blade; a rotor shaft disposed in a center of the rotating body; a magnetic bearing that levitates and supports the rotor shaft; and a touchdown bearing that is separated, by a gap, from the rotor shaft and supports the rotor shaft when the magnetic bearing is uncontrollable. The bearing protection structure includes a protrusion disposed on at least one of the rotating body and a component around the rotating body, and upon touchdown of the rotor shaft on the touchdown bearing, the rotating body comes into contact with the component around the rotating body through the protrusion so that kinetic energy of the rotating body acting on the touchdown bearing is reduced.

To achieve the above object, yet another aspect of the present invention relates to a vacuum pump rotating body to be levitated and supported by a magnetic bearing disposed in a vacuum pump. The rotating body includes: a rotor blade; and a rotor shaft disposed in a center of the rotor blade, wherein the vacuum pump includes a touchdown bearing that is separated, by a gap, from the rotor shaft and supports the rotor shaft when the magnetic bearing is uncontrollable. The rotating body includes a bearing protection structure configured to protect the touchdown bearing, and the bearing protection structure includes a protrusion configured to, upon touchdown of the rotor shaft on the touchdown bearing, come into contact with a component around the rotating body to reduce kinetic energy of the rotating body acting on the touchdown bearing.

The present invention can reduce the kinetic energy of the rotating body acting on the touchdown bearing when the magnetic bearing is uncontrollable. Problems to be solved, configurations, and advantageous effects other than those described above will be recognized from the following description of embodiments.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF DRAWINGS

FIG. 1 is a vertical cross-sectional view of a turbomolecular pump according to a first embodiment of the present invention;

FIG. 2 is a circuit diagram of an amplifier circuit of the turbomolecular pump shown in FIG. 1;

FIG. 3 is a time chart showing control of an amplifier control circuit performed when a current command value is greater than a detected value;

FIG. 4 is a time chart showing control of an amplifier control circuit performed when a current command value is less than a detected value;

FIG. 5 is an enlarged view of section A in FIG. 1 showing the relevant portion;

FIG. 6 is a schematic view showing the positional relationship of a plurality of protrusions disposed on a stator column;

FIG. 7 is an enlarged view of a lower touchdown bearing during normal operation of a turbomolecular pump;

FIG. 8 is an enlarged view of the lower touchdown bearing in a state in which the magnetic bearing becomes uncontrollable;

FIG. 9 is an enlarged view of the lower touchdown bearing in a state after the magnetic bearing becomes uncontrollable;

FIG. 10 is an enlarged view showing a protrusion of a turbomolecular pump according to Modification 1-1;

FIG. 11 is an enlarged view showing a protrusion of a turbomolecular pump according to Modification 1-2;

FIG. 12 is an enlarged view showing a protrusion of a turbomolecular pump according to Modification 1-3;

FIG. 13 is an enlarged view showing a protrusion of a turbomolecular pump according to Modification 1-4;

FIG. 14 is an enlarged view showing a protrusion of a turbomolecular pump according to Modification 1-5;

FIG. 15 is an enlarged view showing a storage portion of a turbomolecular pump according to Modification 1-6;

FIG. 16 is a vertical cross-sectional view of a centrifugal pump according to a second embodiment of the present invention;

FIG. 17 is an enlarged view of section B in FIG. 16 showing the relevant portion;

FIG. 18 is an enlarged view showing a storage portion of a centrifugal pump according to Modification 2-1; and

FIG. 19 is an enlarged view showing a storage portion of a centrifugal pump according to Modification 2-2.

### DETAILED DESCRIPTION

Referring to the drawings, embodiments of a vacuum pump according to the present invention are now described.

### First Embodiment

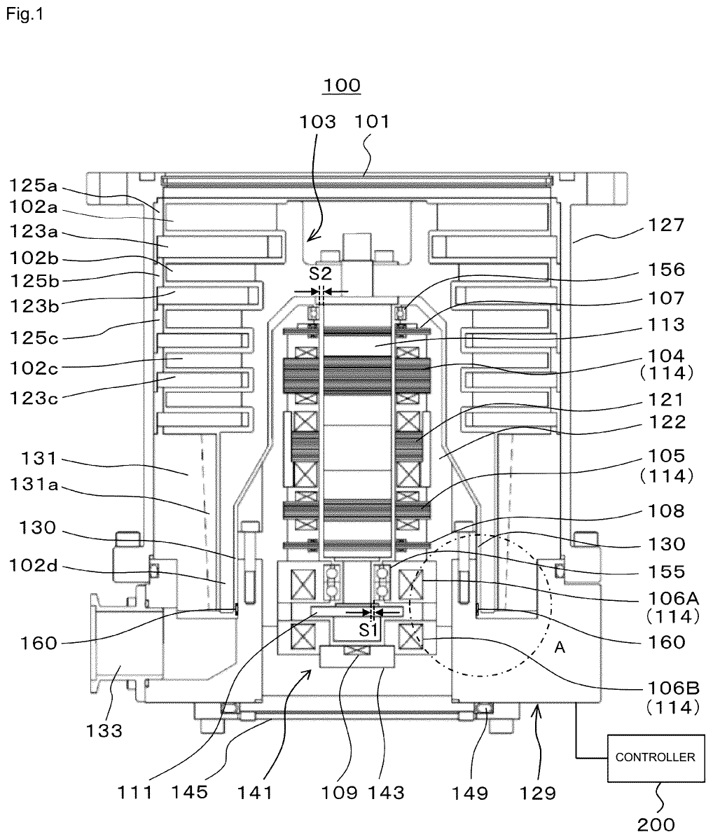

A first embodiment is directed to a turbomolecular pump 100 as an example of a vacuum pump. FIG. 1 is a vertical cross-sectional view of the turbomolecular pump 100. As shown in FIG. 1, the turbomolecular pump 100 has a circular outer cylinder 127 having an inlet port 101 at its upper end. A rotating body 103 in the outer cylinder 127 includes a plurality of rotor blades 102 (102a, 102b, 102c, . . . ), which are turbine blades for gas suction and exhaustion, in its outer circumference section. The rotor blades 102 extend radially in multiple stages. The rotating body 103 has a rotor shaft 113 in its center. The rotor shaft 113 is levitated, supported, and position-controlled by a magnetic bearing 114 of 5-axis control, for example. The rotating body 103 is typically made of a metal such as aluminum or an aluminum alloy.

The magnetic bearing 114 consists of upper radial electromagnets 104, lower radial electromagnets 105, and axial electromagnets 106A and 106B. Upper radial electromagnets 104 include four electromagnets arranged in pairs on an X-axis and a Y-axis. Four upper radial sensors 107 are provided in close proximity to the upper radial electromagnets 104 and associated with the respective upper radial electromagnets 104. Each upper radial sensor 107 may be an inductance sensor or an eddy current sensor having a conduction winding, for example, and detects the position of the rotor shaft 113 based on a change in the inductance of the conduction winding, which changes according to the position of the rotor shaft 113. The upper radial sensors 107 are configured to detect a radial displacement of the rotor shaft 113, that is, the rotating body 103 fixed to the rotor shaft 113, and send it to the controller 200.

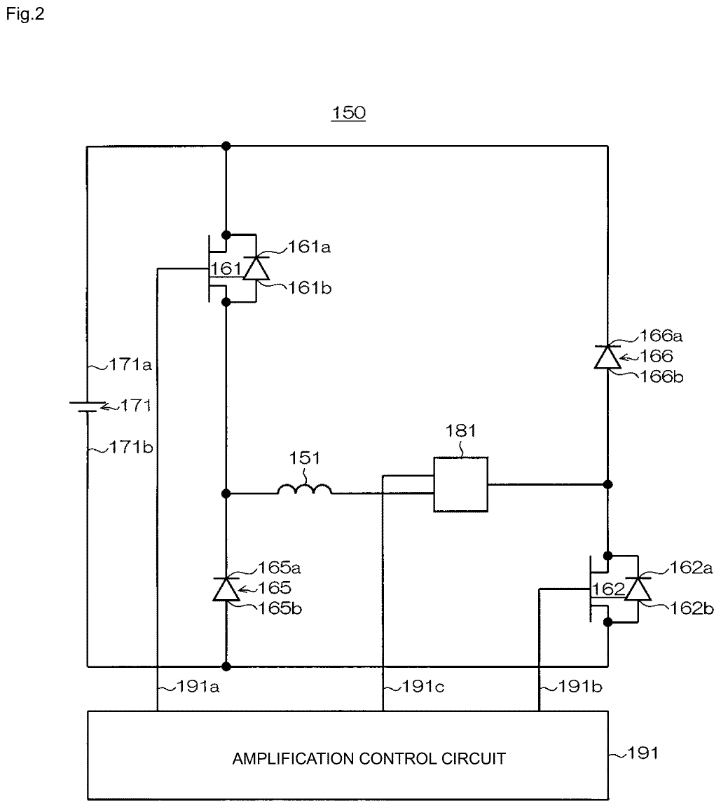

In the controller 200, for example, a compensation circuit having a PID adjustment function generates an excitation control command signal for the upper radial electromagnets 104 based on a position signal detected by the upper radial sensors 107. Based on this excitation control command signal, an amplifier circuit 150 (described below) shown in FIG. 2 controls and excites the upper radial electromagnets 104 to adjust a radial position of an upper part of the rotor shaft 113.

The rotor shaft 113 may be made of a high magnetic permeability material (such as iron and stainless steel) and is configured to be attracted by magnetic forces of the upper radial electromagnets 104. The adjustment is performed independently in the X-axis direction and the Y-axis direction. Lower radial electromagnets 105 and lower radial sensors 108 are arranged in a similar manner as the upper radial electromagnets 104 and the upper radial sensors 107 to adjust the radial position of the lower part of the rotor shaft 113 in a similar manner as the radial position of the upper part.

Additionally, axial electromagnets 106A and 106B are arranged so as to vertically sandwich a metal disc 111, which has a shape of a circular disc and is provided in the lower part of the rotor shaft 113. The metal disc 111 is made of a high magnetic permeability material such as iron. An axial sensor 109 is provided to detect an axial displacement of the rotor shaft 113 and send an axial position signal to the controller 200.

In the controller 200, the compensation circuit having the PID adjustment function may generate an excitation control command signal for each of the axial electromagnets 106A and 106B based on the signal on the axial position detected by the axial sensor 109. Based on these excitation control command signals, the amplifier circuit 150 controls and excites the axial electromagnets 106A and 106B separately so that the axial electromagnet 106A magnetically attracts the metal disc 111 upward and the axial electromagnet 106B attracts the metal disc 111 downward. The axial position of the rotor shaft 113 is thus adjusted.

As described above, the controller 200 appropriately adjusts the magnetic forces exerted by the axial electromagnets 106A and 106B on the metal disc 111, magnetically levitates the rotor shaft 113 in the axial direction, and suspends the rotor shaft 113 in the air in a non-contact manner. The amplifier circuit 150, which controls and excites the upper radial electromagnets 104, the lower radial electromagnets 105, and the axial electromagnets 106A and 106B, is described below.

The motor 121 includes a plurality of magnetic poles circumferentially arranged to surround the rotor shaft 113. Each magnetic pole is controlled by the controller 200 so as to drive and rotate the rotor shaft 113 via an electromagnetic force acting between the magnetic pole and the rotor shaft 113. The motor 121 also includes a rotational speed sensor (not shown), such as a Hall element, a resolver, or an encoder, and the rotational speed of the rotor shaft 113 is detected based on a detection signal of the rotational speed sensor.

Furthermore, a phase sensor (not shown) is attached adjacent to the lower radial sensors 108 to detect the phase of rotation of the rotor shaft 113. The controller 200 detects the position of the magnetic poles using both detection signals of the phase sensor and the rotational speed sensor.

A lower touchdown bearing 155 is provided at the lower end side of the rotor shaft 113. The lower touchdown bearing 155 may be a combined angular contact ball bearing made of stainless steel, for example, and supports the rotor shaft 113 in the radial direction and the thrust direction when the magnetic bearing 114 becomes uncontrollable. The lower touchdown bearing 155 is separated by a gap S1 in the radial direction from the rotor shaft 113. This gap S1 is set to about 0.1 mm. The gap S1 may be in the order of mm, several mm, or the like.

An upper touchdown bearing 156 is provided at the upper end side of the rotor shaft 113. The upper touchdown bearing 156 may be a deep groove ball bearing made of stainless steel, for example, and supports the rotor shaft 113 in the radial direction when the magnetic bearing 114 becomes uncontrollable. The upper touchdown bearing 156 is separated by a gap S2 in the radial direction from the rotor shaft 113. This gap S2 is in the order of 0.1 mm. The gap S2 may be in the order of mm, several mm, or the like.

The lower and upper touchdown bearings 155 and 156 support the rotor shaft 113 in the predetermined directions described above when the magnetic bearing 114 is uncontrollable, thereby preventing damage to the turbomolecular pump 100, which would otherwise occur when the rotor shaft 113 rotating at high speed comes into direct contact with the magnetic bearing 114. The configuration can also prevent direct contact between the rotor blades 102 and the stator blades 123, direct contact between the cylindrical portion 102d of the rotating body 103 and the stator column 122, and direct contact between the metal disc 111 and the axial electromagnets 106A and 106B, and resulting damage to these components.

A plurality of stator blades 123 (123a, 123b, 123c, . . . ) are arranged slightly spaced apart from the rotor blades 102 (102a, 102b, 102c, . . . ). Each rotor blade 102 (102a, 102b, 102c, . . . ) is inclined by a predetermined angle from a plane perpendicular to the axis of the rotor shaft 113 in order to transfer exhaust gas molecules downward through collision. The stator blades 123 (123a, 123b, 123c, . . . ) are made of a metal such as aluminum, iron, stainless steel, copper, or a metal such as an alloy containing these metals as components.

The stator blades 123 are also inclined by a predetermined angle from a plane perpendicular to the axis of the rotor shaft 113. The stator blades 123 extend inward of the outer cylinder 127 and alternate with the stages of the rotor blades 102. The outer circumference ends of the stator blades 123 are inserted between and thus supported by a plurality of layered stator blade spacers 125 (125a, 125b, 125c, . . . ).

The stator blade spacers 125 are ring-shaped members made of a metal, such as aluminum, iron, stainless steel, or copper, or an alloy containing these metals as components, for example. The outer cylinder 127 is fixed to the outer circumferences of the stator blade spacers 125 with a slight gap. A base portion 129 is located at the base of the outer cylinder 127. The base portion 129 has an outlet port 133 providing communication to the outside. The exhaust gas transferred to the base portion 129 through the inlet port 101 from the chamber (vacuum chamber) side is then sent to the outlet port 133.

According to the application of the turbomolecular pump 100, a threaded spacer 131 may be provided between the lower part of the stator blade spacer 125 and the base portion 129. The threaded spacer 131 is a cylindrical member made of a metal such as aluminum, copper, stainless steel, or iron, or an alloy containing these metals as components. The threaded spacer 131 has a plurality of helical thread grooves 131a in its inner circumference surface. When exhaust gas molecules move in the rotation direction of the rotating body 103, these molecules are transferred toward the outlet port 133 in the direction of the helix of the thread grooves 131a. In the lowermost section of the rotating body 103 below the rotor blades 102 (102a, 102b, 102c, . . . ), a cylindrical portion 102d extends downward. The outer circumference surface of the cylindrical portion 102d is cylindrical and projects toward the inner circumference surface of the threaded spacer 131. The outer circumference surface is adjacent to but separated from the inner circumference surface of the threaded spacer 131 by a predetermined gap. The exhaust gas transferred to the thread grooves 131a by the rotor blades 102 and the stator blades 123 is guided by the thread grooves 131a to the base portion 129.

The base portion 129 is a disc-shaped member forming the base section of the turbomolecular pump 100, and is generally made of a metal such as iron, aluminum, or stainless steel. The base portion 129 physically holds the turbomolecular pump 100 and also serves as a heat conduction path. As such, the base portion 129 is preferably made of rigid metal with high thermal conductivity, such as iron, aluminum, or copper.

In this configuration, when the motor 121 drives and rotates the rotor blades 102 together with the rotor shaft 113, the interaction between the rotor blades 102 and the stator blades 123 causes the suction of exhaust gas from the chamber through the inlet port 101. The rotational speed of the rotor blades 102 is usually 20000 rpm to 90000 rpm, and the circumferential speed at the tip of a rotor blade 102 reaches 200 m/s to 400 m/s. The exhaust gas taken through the inlet port 101 moves between the rotor blades 102 and the stator blades 123 and is transferred to the base portion 129. At this time, factors such as the friction heat generated when the exhaust gas comes into contact with the rotor blades 102 and the conduction of heat generated by the motor 121 increase the temperature of the rotor blades 102. This heat is conducted to the stator blades 123 through radiation or conduction via gas molecules of the exhaust gas, for example.

The stator blade spacers 125 are joined to each other at the outer circumference portion and conduct the heat received by the stator blades 123 from the rotor blades 102, the friction heat generated when the exhaust gas comes into contact with the stator blades 123, and the like to the outside.

In the above description, the threaded spacer 131 is provided at the outer circumference of the cylindrical portion 102d of the rotating body 103, and the thread grooves 131a are engraved in the inner circumference surface of the threaded spacer 131. However, this may be inversed in some cases, and a thread groove may be engraved in the outer circumference surface of the cylindrical portion 102d, while a spacer having a cylindrical inner circumference surface may be arranged around the outer circumference surface.

According to the application of the turbomolecular pump 100, to prevent the gas drawn through the inlet port 101 from entering an electrical portion, which includes the upper radial electromagnets 104, the upper radial sensors 107, the motor 121, the lower radial electromagnets 105, the lower radial sensors 108, the axial electromagnets 106A, 106B, and the axial sensor 109, the electrical portion may be surrounded by the stator column 122. The stator column 122 is arranged at the inner circumference side of the rotating body 103 and at the outer circumference side of the rotor shaft 113. The inside of the stator column 122 may be maintained at a predetermined pressure by purge gas.

In this case, the base portion 129 has a pipe (not shown) through which the purge gas is introduced. The introduced purge gas is sent to the outlet port 133 through a purge gas flow passage 130 between the lower touchdown bearing 155 and the rotor shaft 113, between the rotor and the stator of the motor 121, and between the inner circumference surface of the rotating body 103 and the outer circumference surface of the stator column 122. A plurality of protrusions 160 are formed on the outer circumference surface of the stator column 122. When the magnetic bearing 114 is uncontrollable, these protrusions 160 come into contact with the inner circumference surface of the rotating body 103, thereby reducing the kinetic energy of the rotating body 103. This will be described in detail below.

The turbomolecular pump 100 requires the identification of the model and control based on individually adjusted unique parameters (for example, various characteristics associated with the model). To store these control parameters, the turbomolecular pump 100 includes an electronic circuit portion 141 in its main body. The electronic circuit portion 141 may include a semiconductor memory, such as an EEPROM, electronic components such as semiconductor elements for accessing the semiconductor memory, and a substrate 143 for mounting these components. The electronic circuit portion 141 is housed under a rotational speed sensor (not shown) near the center, for example, of the base portion 129, which forms the lower part of the turbomolecular pump 100, and is closed by an airtight bottom lid 145.

Some process gas introduced into the chamber in the manufacturing process of semiconductors has the property of becoming solid when its pressure becomes higher than a predetermined value or its temperature becomes lower than a predetermined value. In the turbomolecular pump 100, the pressure of the exhaust gas is lowest at the inlet port 101 and highest at the outlet port 133. When the pressure of the process gas increases beyond a predetermined value or its temperature decreases below a predetermined value while the process gas is being transferred from the inlet port 101 to the outlet port 133, the process gas is solidified and adheres and accumulates on the inner side of the turbomolecular pump 100.

For example, when SiCl4 is used as the process gas in an Al etching apparatus, according to the vapor pressure curve, a solid product (for example, AlCl3) is deposited at a low vacuum (760 [torr] to 10-2 [torr]) and a low temperature (about 20 [° C.]) and adheres and accumulates on the inner side of the turbomolecular pump 100. When the deposit of the process gas accumulates in the turbomolecular pump 100, the accumulation may narrow the pump flow passage and degrade the performance of the turbomolecular pump 100. The above-mentioned product tends to solidify and adhere in areas with higher pressures, such as the vicinity of the outlet port and the vicinity of the threaded spacer 131.

To solve this problem, conventionally, a heater or annular water-cooled tube 149 (not shown) is wound around the outer circumference of the base portion 129, and a temperature sensor (e.g., a thermistor, not shown) is embedded in the base portion 129, for example. The signal of this temperature sensor is used to perform control to maintain the temperature of the base portion 129 at a constant high temperature (preset temperature) by heating with the heater or cooling with the water-cooled tube 149 (hereinafter referred to as TMS (temperature management system)).

The amplifier circuit 150 is now described that controls and excites the upper radial electromagnets 104, the lower radial electromagnets 105, and the axial electromagnets 106A and 106B of the turbomolecular pump 100 configured as described above. FIG. 2 is a circuit diagram of the amplifier circuit 150.

In FIG. 2, one end of an electromagnet winding 151 forming an upper radial electromagnet 104 or the like is connected to a positive electrode 171a of a power supply 171 via a transistor 161, and the other end is connected to a negative electrode 171b of the power supply 171 via a current detection circuit 181 and a transistor 162. Each transistor 161, 162 is a power MOSFET and has a structure in which a diode is connected between the source and the drain thereof.

In the transistor 161, a cathode terminal 161a of its diode is connected to the positive electrode 171a, and an anode terminal 161b is connected to one end of the electromagnet winding 151. In the transistor 162, a cathode terminal 162a of its diode is connected to a current detection circuit 181, and an anode terminal 162b is connected to the negative electrode 171b.

A diode 165 for current regeneration has a cathode terminal 165a connected to one end of the electromagnet winding 151 and an anode terminal 165b connected to the negative electrode 171b. Similarly, a diode 166 for current regeneration has a cathode terminal 166a connected to the positive electrode 171a and an anode terminal 166b connected to the other end of the electromagnet winding 151 via the current detection circuit 181. The current detection circuit 181 may include a Hall current sensor or an electric resistance element, for example.

The amplifier circuit 150 configured as described above corresponds to one electromagnet. Accordingly, when the magnetic bearing uses 5-axis control and has ten electromagnets 104, 105, 106A, and 106B in total, an identical amplifier circuit 150 is configured for each of the electromagnets. These ten amplifier circuits 150 are connected to the power supply 171 in parallel.

An amplifier control circuit 191 may be formed by a digital signal processor portion (not shown, hereinafter referred to as a DSP portion) of the controller 200. The amplifier control circuit 191 switches the transistors 161 and 162 between on and off.

The amplifier control circuit 191 is configured to compare a current value detected by the current detection circuit 181 (a signal reflecting this current value is referred to as a current detection signal 191c) with a predetermined current command value. The result of this comparison is used to determine the magnitude of the pulse width (pulse width time Tp1, Tp2) generated in a control cycle Ts, which is one cycle in PWM control. As a result, gate drive signals 191a and 191b having this pulse width are output from the amplifier control circuit 191 to gate terminals of the transistors 161 and 162.

Under certain circumstances such as when the rotational speed of the rotating body 103 reaches a resonance point during acceleration, or when a disturbance occurs during a constant speed operation, the rotating body 103 may require positional control at high speed and with a strong force. For this purpose, a high voltage of about 50 V, for example, is used for the power supply 171 to enable a rapid increase (or decrease) in the current flowing through the electromagnet winding 151. Additionally, a capacitor is generally connected between the positive electrode 171a and the negative electrode 171b of the power supply 171 to stabilize the power supply 171 (not shown).

In this configuration, when both transistors 161 and 162 are turned on, the current flowing through the electromagnet winding 151 (hereinafter referred to as an electromagnet current iL) increases, and when both are turned off, the electromagnet current iL decreases.

Also, when one of the transistors 161 and 162 is turned on and the other is turned off, a freewheeling current is maintained. Passing the freewheeling current through the amplifier circuit 150 in this manner reduces the hysteresis loss in the amplifier circuit 150, thereby limiting the power consumption of the entire circuit to a low level. Moreover, by controlling the transistors 161 and 162 as described above, high frequency noise, such as harmonics, generated in the turbomolecular pump 100 can be reduced. Furthermore, by measuring this freewheeling current with the current detection circuit 181, the electromagnet current iL flowing through the electromagnet winding 151 can be detected.

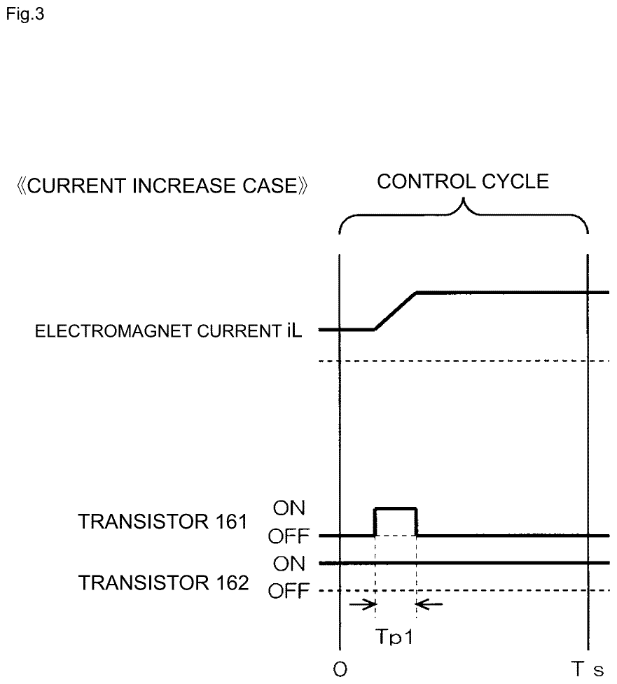

That is, when the detected current value is smaller than the current command value, as shown in FIG. 3, the transistors 161 and 162 are simultaneously on only once in the control cycle Ts (for example, 100 μs) for the time corresponding to the pulse width time Tp1. During this time, the electromagnet current iL increases accordingly toward the current value iLmax (not shown) that can be passed from the positive electrode 171a to the negative electrode 171b via the transistors 161 and 162.

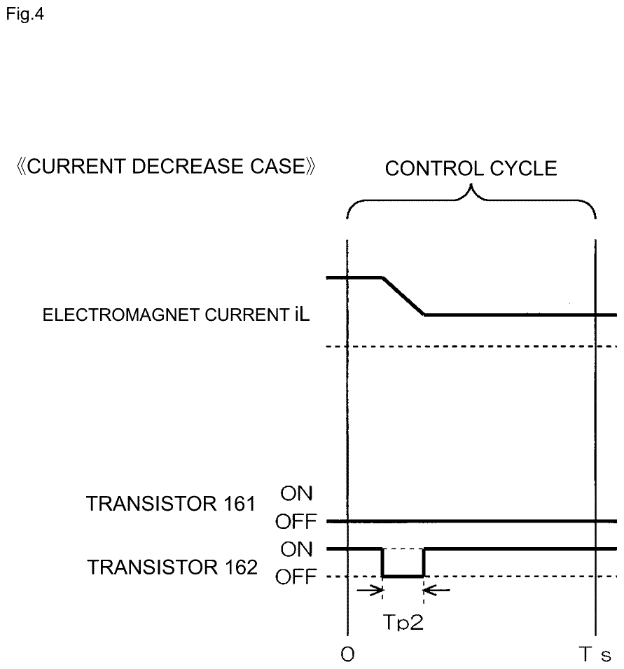

When the detected current value is larger than the current command value, as shown in FIG. 4, the transistors 161 and 162 are simultaneously off only once in the control cycle Ts for the time corresponding to the pulse width time Tp2. During this time, the electromagnet current iL decreases accordingly toward the current value iLmin (not shown) that can be regenerated from the negative electrode 171b to the positive electrode 171a via the diodes 165 and 166.

In either case, after the pulse width time Tp1, Tp2 has elapsed, one of the transistors 161 and 162 is on. During this period, the freewheeling current is thus maintained in the amplifier circuit 150.

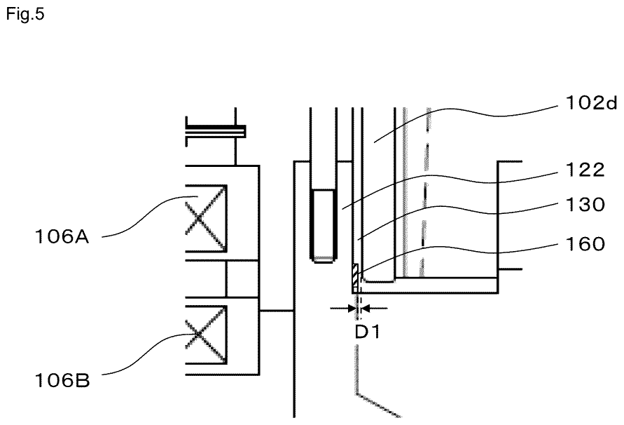

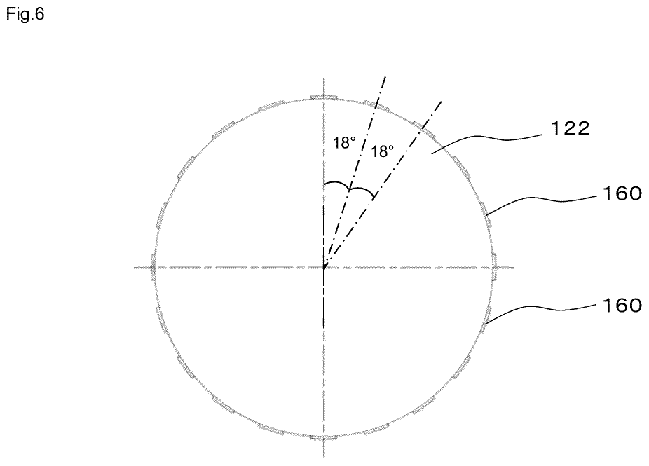

The characteristic portion of the turbomolecular pump 100 according to the first embodiment is now described in detail. FIG. 5 is an enlarged view of section A in FIG. 1 showing the relevant portion, and FIG. 6 is a schematic view showing the positional relationship of the protrusions 160 disposed on the stator column 122.

As shown in FIG. 5, the protrusions 160 are disposed in the purge gas flow passage 130. Specifically, these protrusions 160 are disposed on the circumference surface of the lower part of the stator column 122. The protrusions 160 are placed at positions that are adjacent to the downstream end of the rotating body 103 (that is, adjacent to the lower end of the cylindrical portion 102d of the rotating body 103) and relatively close to the outlet port 133 (FIG. 1). As shown in FIG. 6, the protrusions 160 are arranged at regular intervals in the circumferential direction of the stator column 122 as viewed in the axial direction of the stator column 122. The present embodiment includes 20 protrusions 160 arranged at intervals of 18 degrees in the circumferential direction of the stator column 122.

Each protrusion 160 is formed by machining the outer circumference surface of the stator column 122 so as to have a rectangular cross-sectional shape. The protrusions 160 protrude from the outer circumference surface of the stator column 122 toward the cylindrical portion 102d of the rotating body 103. The protrusions 160 function as a bearing protection structure that protects the lower and upper touchdown bearings 155 and 156 by coming into contact with the cylindrical portion 102d upon a touchdown of the rotor shaft 113 on the upper and lower touchdown bearings 155 and 156. The protrusions 160 may be formed through thermal spraying of a metal such as ceramic.

The width D1 (see FIG. 5) of the purge gas flow passage 130 in which the protrusions 160 are formed corresponds to the distance between the distal end surfaces of the protrusions 160 and the cylindrical portion 102d of the rotating body 103. The width D1 is larger than the gap S1 (see FIG. 1) between the lower touchdown bearing 155 and the rotor shaft 113. Also, the width D1 is less than the value obtained by adding the gap S1 to the margin (internal gap in the radial direction) S1′ of the lower touchdown bearing 155. That is, the relation S1<D1<(S1+S1′) holds. As a result, when the magnetic bearing 114 becomes uncontrollable, the rotor shaft 113 first comes into contact with the lower touchdown bearing 155, and then the protrusions 160 come into contact with the cylindrical portion 102d. That is, when the rotating body 103 is normally levitated and supported by the magnetic bearing 114, the rotor shaft 113 does not come into contact with the lower touchdown bearing 155, or the protrusions 160 do not come into contact with the cylindrical portion 102d.

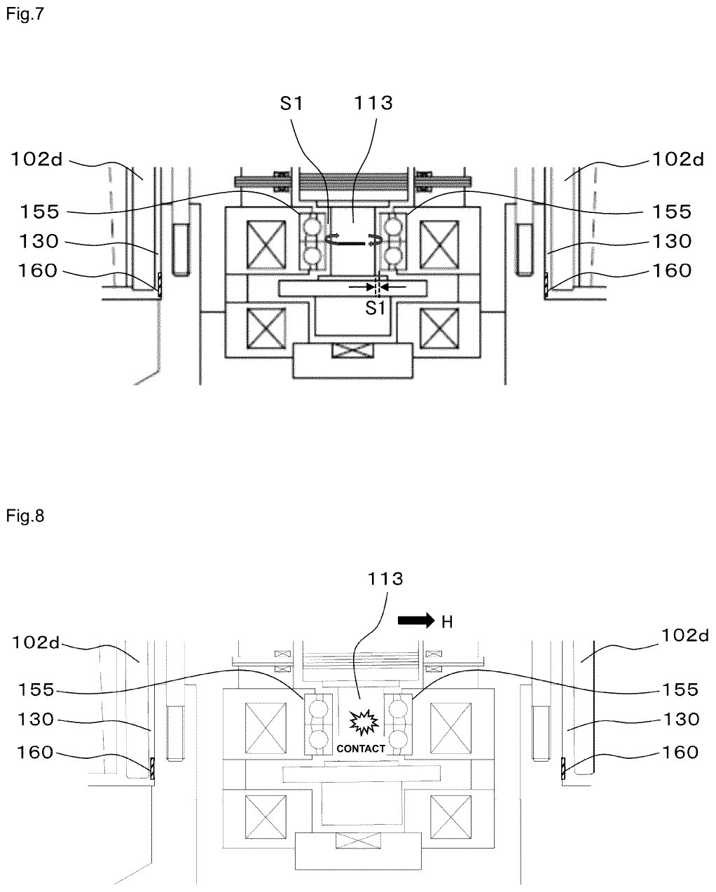

When the magnetic bearing 114 becomes uncontrollable during operation of the turbomolecular pump 100, the state of contact between the protrusions 160 and the cylindrical portion 102d of the rotating body 103 changes as described below with reference to FIGS. 7 to 9.

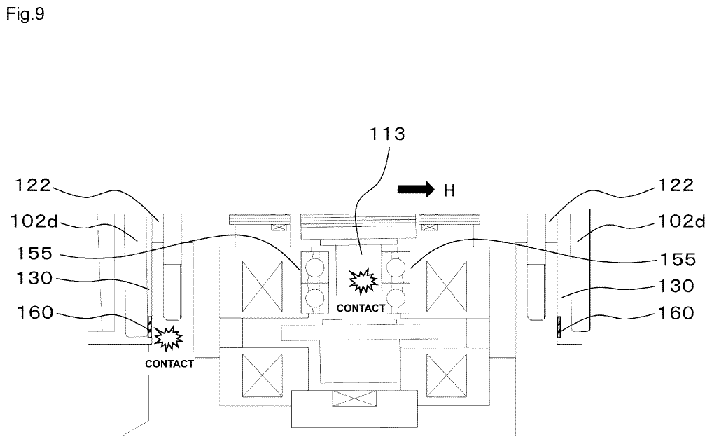

FIG. 7 is an enlarged view of the lower touchdown bearing 155 during normal operation of the turbomolecular pump 100. FIG. 8 is an enlarged view of the lower touchdown bearing 155 in a state in which the magnetic bearing 114 becomes uncontrollable. FIG. 9 is an enlarged view of the lower touchdown bearing 155 in a state after (immediately after) the magnetic bearing 114 becomes uncontrollable.

As shown in FIG. 7, while the turbomolecular pump 100 operates, the rotating body 103 continues to rotate at high speed in the direction of arrows in FIG. 7. The lower touchdown bearing 155 is stationary with the gap S1 to the rotor shaft 113 of the rotating body 103 maintained.

As shown in FIG. 8, an external factor arising during operation of the turbomolecular pump 100 (for example, power failure (power source loss or power loss), excessive vibration of the turbomolecular pump 100, suction of a large amount of gas through the inlet port 101, incorrect use of the turbomolecular pump 100 by the operator, or operator error) may cause the magnetic bearing 114 to become uncontrollable. In such a case, the rotating body 103 rotating at high speed loses its balance and is displaced (tilted) in the direction of arrow H in FIG. 8 while rotating. Then, when the rotor shaft 113 of the rotating body 103 moves by the gap S1 in the direction of arrow H, the rotor shaft 113 comes into contact with the lower touchdown bearing 155. At this time, the lower touchdown bearing 155 absorbs the kinetic energy held by the rotating body 103. The kinetic energy of the rotating body 103 is a value calculated by (the moment of inertia I of the rotating body 103)×(the square of the angular velocity ω of the rotating body 103), and this moment of inertia I is proportional to the weight of the rotating body 103. As such, a greater weight of the rotating body 103 increases the moment of inertia I of the rotating body 103, thus increasing the kinetic energy of the rotating body 103.

As shown in FIG. 9, immediately after (at about the same time as when) the rotor shaft 113 of the rotating body 103 comes into contact with the lower touchdown bearing 155, the rotor shaft 113 in contact with the lower touchdown bearing 155 may be further pushed in the direction of arrow H in FIG. 9 (rightward) within the range of the margin S1′ of the lower touchdown bearing 155, bringing the cylindrical portion 102d of the rotating body 103 into contact with the protrusions 160. That is, the cylindrical portion 102d comes into contact with the stator column 122 through the protrusions 160. This contact converts the kinetic energy held by the rotating body 103 into frictional heat. Accordingly, the kinetic energy held by the rotating body 103 is absorbed not only by the lower touchdown bearing 155 but also by the portion of the cylindrical portion 102d in contact with the protrusions 160. This reduces the kinetic energy of the rotating body 103 acting on the lower touchdown bearing 155.

When the magnetic bearing 114 becomes uncontrollable causing the rotor shaft 113 of the rotating body 103 to move by the gap S2 (FIG. 1) in a predetermined direction, the upper touchdown bearing 156 comes into contact with the rotor shaft 113 and continues to support the rotor shaft 113 in the radial direction. The kinetic energy held by the rotating body 103 is thus absorbed.

The first embodiment configured as described above has the following advantageous effects.

The protrusions 160 are formed on the stator column 122 (a component around the rotating body 103) as a bearing protection structure that protects the lower and upper touchdown bearings 155 and 156. As such, when the magnetic bearing 114 becomes uncontrollable causing a touchdown of the rotor shaft 113 on the lower and upper touchdown bearings 155 and 156, the rotating body 103 comes into contact with the stator column 122 through the protrusions 160. This reduces the kinetic energy of the rotating body 103 acting on the lower and upper touchdown bearings 155 and 156.

Also, since the protrusions 160 are disposed on the outer circumference surface of the stator column 122, the kinetic energy of the rotating body 103 is efficiently reduced without increasing the weight of the rotating body 103.

Moreover, the protrusions 160 are disposed in the purge gas flow passage 130, ensuring that any contaminants created by contact between the protrusions 160 and the cylindrical portion 102d of the rotating body 103 are discharged through this purge gas flow passage 130. In particular, the protrusions 160 are arranged adjacent to the downstream end of the rotating body 103 and located close to the outlet port 133. This is significantly effective in discharging contaminants.

As viewed in the axial direction of the stator column 122, the protrusions 160 are arranged at regular intervals in the circumferential direction of the stator column 122. This allows the rotating body 103 to come into contact with the stator column 122 through the protrusions 160 at substantially the same pitch. Accordingly, the kinetic energy of the rotating body 103 is gradually reduced. Thus, the kinetic energy of the rotating body 103 is less likely to be abruptly absorbed. This prevents damage to various devices in the turbomolecular pump 100, which would otherwise occur due to the contact between the rotating body 103 and the stator column 122. Also, the regular intervals of the protrusions 160 maintain the rotation balance of the rotating body 103.

### Modification 1-1

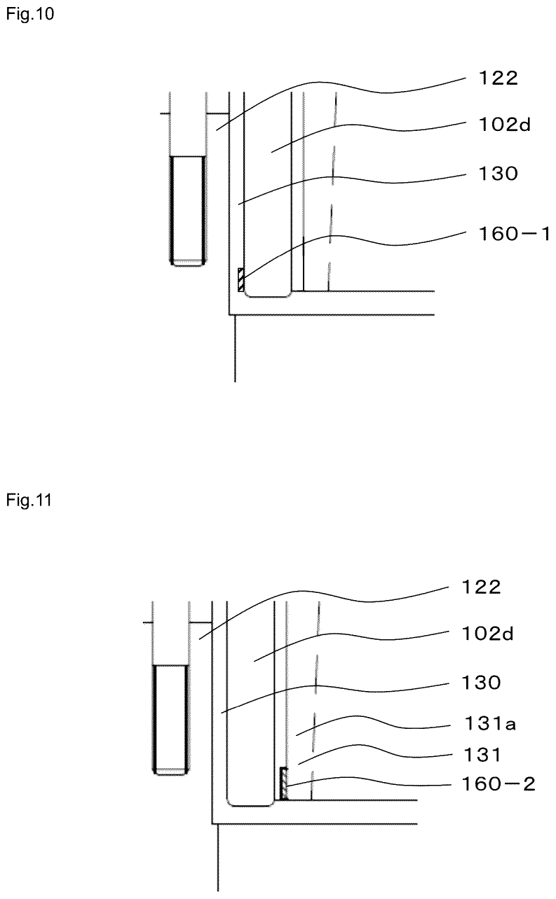

FIG. 10 is an enlarged view showing a protrusion 160-1 of a turbomolecular pump according to Modification 1-1. As shown in FIG. 10, the protrusion 160-1 differs from the first embodiment in that it is formed on the cylindrical portion 102d of the rotating body 103. Specifically, the protrusion 160-1 is formed at the lower end portion of the inner circumference surface of the cylindrical portion 102d. This configuration has the same advantageous effects as the first embodiment.

### Modification 1-2

FIG. 11 is an enlarged view showing a protrusion 160-2 of a turbomolecular pump 100 according to Modification 1-2. As shown in FIG. 11, the protrusion 160-2 differs from the first embodiment in that it is formed on the threaded spacer 131 located outside the cylindrical portion 102d of the rotating body 103. Specifically, the protrusion 160-2 is formed on the lower end portion of the inner circumference surface of the threaded spacer 131. This configuration has the same advantageous effects as the first embodiment.

### Modification 1-3

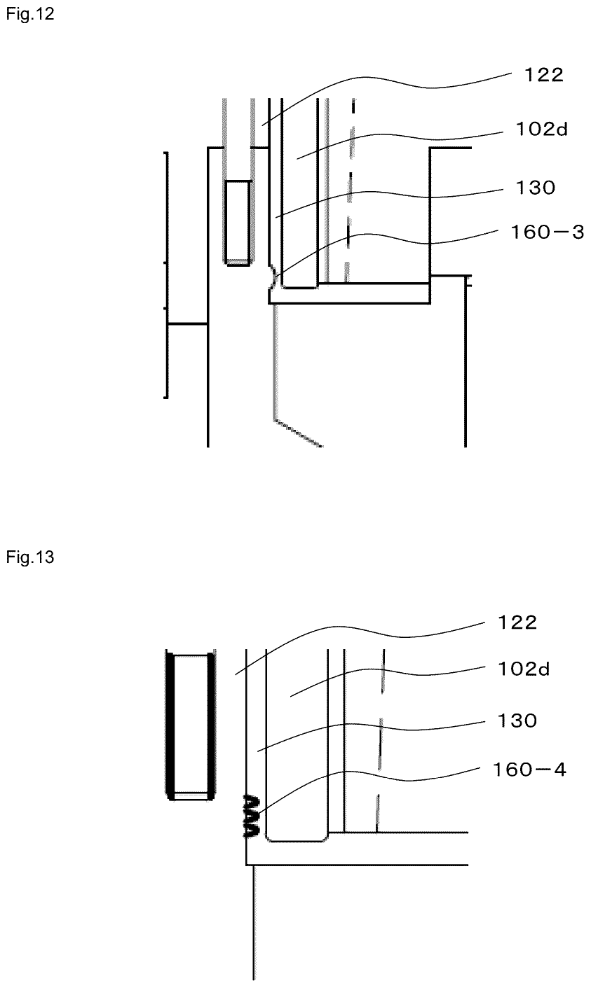

FIG. 12 is an enlarged view showing a protrusion 160-3 of a turbomolecular pump according to Modification 1-3. As shown in FIG. 12, the protrusion 160-3 differs from the first embodiment in shape. Specifically, the protrusion 160-3 has a curved end and thus has a lower friction property than the first embodiment.

As compared to the first embodiment, this configuration smoothly absorbs the kinetic energy of the rotating body 103 through the contact between the protrusions 160-3 and the cylindrical portion 102d of the rotating body 103. Also, the area of contact between the protrusions 160-3 and the cylindrical portion 102d is reduced, minimizing the creation of contaminants.

### Modification 1-4

FIG. 13 is an enlarged view showing a protrusion 160-4 of a turbomolecular pump according to Modification 1-4. As shown in FIG. 13, the protrusion 160-4 is formed in a labyrinth shape (pleated). The protrusion 160-4 also has a lower friction property than the first embodiment.

This configuration has the same advantageous effects as Modification 1-3. Moreover, the configuration achieves the smooth absorption of the kinetic energy of the rotating body 103 and the reduced creation of contaminants in a well-balanced manner.

### Modification 1-5

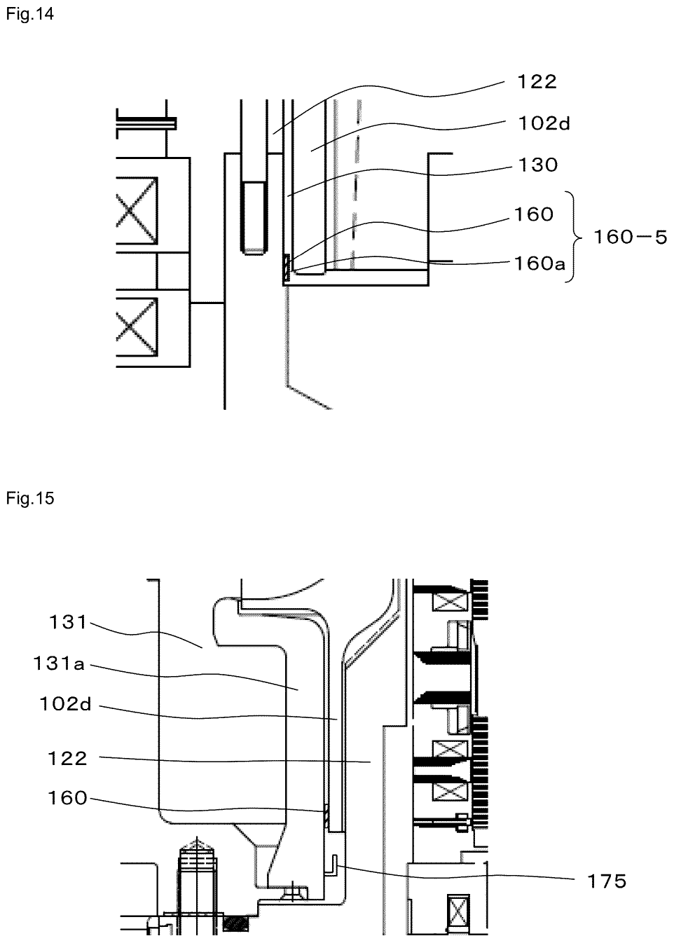

FIG. 14 is an enlarged view showing a protrusion 160-5 of a turbomolecular pump according to Modification 1-5. As shown in FIG. 14, the surface of the protrusion 160-5 is covered with a coating portion 160a made of a resin material such as heat-resistant PTFE. The coating portion 160a has a lower friction property than the rotating body 103 and the stator column 122.

This configuration smoothly absorbs the kinetic energy of the rotating body 103 while securing the sufficient area of contact between the protrusion 160-5 and the cylindrical portion 102d of the rotating body 103.

### Modification 1-6

FIG. 15 is an enlarged view showing a turbomolecular pump according to Modification 1-6. As shown in FIG. 15, this turbomolecular pump includes a plurality of protrusions 160, which are formed on the outer circumference surface of the cylindrical portion 102d of the rotating body 103, and a storage portion 175, which has an L-shaped cross-section and is disposed at a position downstream of the protrusions 160 in the flow direction of exhaust gas to store contaminants.

According to this configuration, any contaminants created by contact between the cylindrical portion 102d of the rotating body 103 and the threaded spacer 131 fall downward and are stored in the storage portion 175. This prevents the contaminants from scattering in the turbomolecular pump.

### Second Embodiment

A vacuum pump according to a second embodiment is now described. The second embodiment is directed to a centrifugal pump 110 as an example of a vacuum pump. Same reference numerals are given to those configurations that are the same as the corresponding configurations of the first embodiment. Such configurations will not be described in detail.

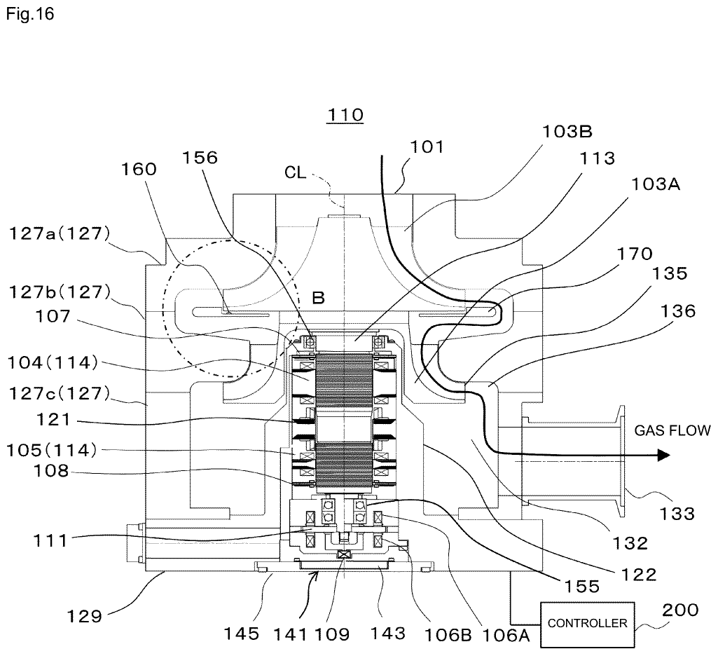

FIG. 16 is a vertical cross-sectional view of the centrifugal pump 110. As shown in FIG. 16, the centrifugal pump 110 includes a circular outer cylinder 127 (127a, 127b, 127c), which can be vertically divided into three stages and has an inlet port 101 at its upper end. Impellers (rotor blades) 103A and 103B for gas suction and exhaustion are provided in multiple stages inside the outer cylinder (casing) 127. The impellers 103A and 103B are arranged along a central axis CL, and the impeller 103B is closer to the inlet port 101 than the impeller 103A. A rotor shaft 113 is provided at the centers of the impellers 103B and 103A. The impellers 103A and 103B may be the same or different from each other in structure (configuration).

The impellers 103A and 103B are typically made of a metal such as aluminum or an aluminum alloy. Of course, the metal used for the impeller 103A and the impeller 103B is not limited to these. For example, the impellers 103A and 103B may be made of a metal such as stainless steel, a titanium alloy, or a nickel alloy.

A back plate 170 is provided at the back side of the impeller 103B to prevent disturbance of exhaust gas (occurrence of backflow). The back plate 170 is a planar member formed in an annular shape and has an inner circumference surface separated by a predetermined gap from the rotor shaft 113 in the radial direction. The inner circumference side of the back plate 170 is recessed as compared with the outer circumference side and separated from the outer circumference portion of the impeller 103B by a gap in the axial direction. The outer circumference side of the back plate 170 is positioned side by side with the outer circumference portion of the impeller 103A with a gap in the radial direction in between. In a similar manner as the first embodiment, a plurality of protrusions 160 are formed on the inner circumference side of the back plate 170, as will be described in detail below.

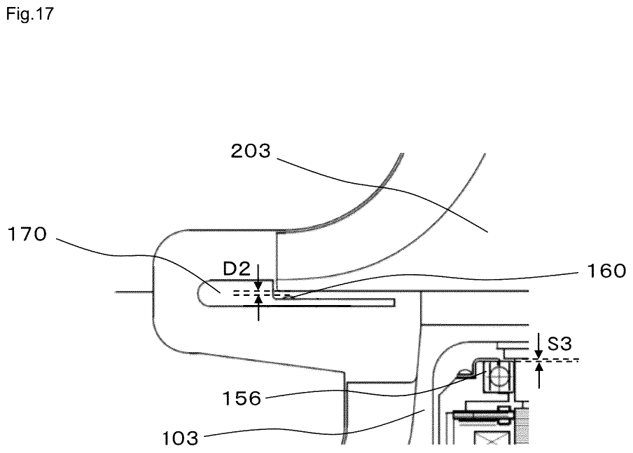

The upper touchdown bearing 156 is separated by a gap S3 in the axial direction from the rotor shaft 113 (see FIG. 17). As in the first embodiment, the lower touchdown bearing 155 is provided at the lower end side of the rotor shaft 113.

As indicated by the arrow in FIG. 16, in the second embodiment, the gas drawn downward through the inlet port 101 along the central axis CL is turned to the radial direction by the impeller 103B and then guided to the impeller 103A. The gas is then discharged from a gas outlet 135 of the impeller 103A, circulates in an annular buffer space 136, and is discharged from the outlet port 133 via an internal space 132. The internal space 132 is an annular space formed between the outer cylinder 127 and the stator column 122 and continuous with the buffer space 136.

The characteristic portion of the centrifugal pump 110 according to the second embodiment is now described in detail. FIG. 17 is an enlarged view of section B in FIG. 16 showing the relevant portion. As shown in FIG. 17, a plurality of protrusions 160 are formed on a surface of the inner circumference side of the back plate 170. These protrusions 160 face the back surface of the outer circumference portion of the impeller 103B. Each protrusion 160 has a curved shape. Of course, the protrusion 160 may also have a labyrinth shape or be covered with a coating portion as described above in the modifications of the first embodiment, for example. Although not shown, the protrusions 160 are arranged at regular intervals in the circumferential direction of the back plate 170 as viewed in the axial direction of the back plate 170.

The width D2 between the distal ends of the protrusions 160 and the back surface of the impeller 103B is larger than the gap S3 between the upper touchdown bearing 156 and the rotor shaft 113. Also, the width D2 is less than the value obtained by adding the gap S3 to the margin (internal gap in the axial direction) S3′ of the upper touchdown bearing 156. That is, the relation S3<D2<(S3+S3′) holds. As a result, when the magnetic bearing 114 becomes uncontrollable, the rotor shaft 113 first comes into contact with the upper touchdown bearing 156, and then the protrusions 160 come into contact with the back surface of the back plate 170. That is, when the rotating body 103 is normally levitated and supported by the magnetic bearing 114, the rotor shaft 113 does not come into contact with the upper touchdown bearing 156, or the protrusions 160 do not come into contact with the back plate 170.

In the centrifugal pump 110 thus configured, when the magnetic bearing 114 becomes uncontrollable, the rotating body (impellers 103A and 103B) loses its balance and falls by its own weight while rotating. Then, when the rotor shaft 113 moves downward by the gap S3, the rotor shaft 113 comes into contact with the upper touchdown bearing 156. At about the same time, the rotor shaft 113 in contact with the upper touchdown bearing 156 may move downward within the range of the margin S3′ of the upper touchdown bearing 156, bringing the protrusions 160 into contact with the back surface of the back plate 170. That is, the impeller 103B comes into contact with the back plate 170 through the protrusions 160. Accordingly, in the same manner as the first embodiment, the kinetic energy held by the rotating body is absorbed not only by the upper touchdown bearing 156 but also by the portion of the back surface of the impeller 103B in contact with the protrusions 160. This reduces the kinetic energy of the rotating body acting on the upper touchdown bearing 156.

Although not described in detail, in the same manner as the upper touchdown bearing 156, the lower touchdown bearing 155 also absorbs the kinetic energy held by the rotating body 103 when the magnetic bearing 114 is uncontrollable.

As described above, the second embodiment has the same advantageous effects as the first embodiment. Additionally, the second embodiment, which includes the impellers 103A and 103B in multiple stages, is suitable for a large-capacity vacuum pump.

### Modification 2-1

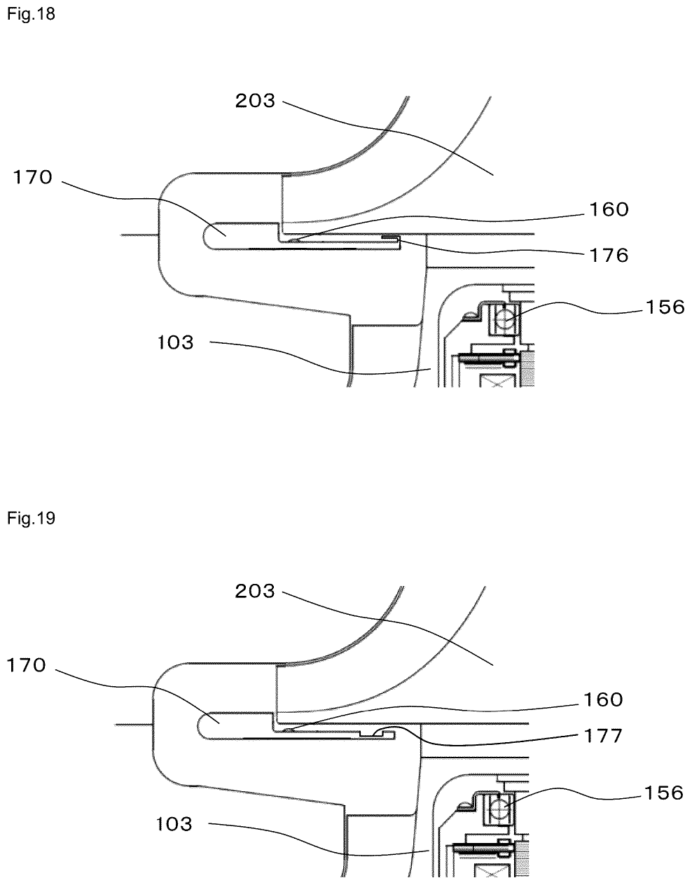

FIG. 18 is an enlarged view showing a storage portion 176 of a centrifugal pump according to Modification 2-1. As shown in FIG. 18, the storage portion 176 for storing contaminants is formed on the inner circumference side of the back plate 170 and located downstream of the protrusions 160. The storage portion 176 is formed in the shape of letter U at the end of the inner circumference side of the back plate 170 to stop the contaminants moving in the downstream direction from the protrusions 160.

This configuration stops any contaminants created by contact between the protrusions 160 and the back surface of the impeller 103B with the storage portion 176, preventing the contaminants from scattering in the centrifugal pump 110.

### Modification 2-2

FIG. 19 is an enlarged view showing a storage portion of a centrifugal pump according to Modification 2-2. As shown in 19, a storage portion 177 is a recess formed in the inner circumference side of the back plate 170 and located downstream of the protrusions 160. Contaminants moving in the downstream direction from the protrusions 160 fall and accumulate in the storage portion 177. This configuration thus has the same advantageous effect as Modification 2-1.

The present invention is not limited to the embodiments described above, and various modifications can be made without departing from the scope of the present invention. The present invention encompasses all technical matters included in the technical idea described in the claims. Although the foregoing embodiments illustrate preferred examples, other alternation, variations, modifications, and combinations, or improvements will be apparent to those skilled in the art from the content disclosed herein, and may be made without departing from the technical scope defined by the appended claims.

For example, in the first embodiment, the protrusions 160 may be disposed on at least one of the rotating body 103 or the stator column 122. That is, these protrusions 160 may be disposed on both the rotating body 103 and the stator column 122.

In the second embodiment, the protrusions 160 may be disposed on at least one of the impeller 103B or the back plate 170. That is, these protrusions 160 may be disposed on both the impeller 103B and the back plate 170.

The first and second embodiments include a plurality of protrusions 160. However, the present invention is not limited to this configuration, and only one protrusion 160 may be provided.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A vacuum pump comprising:
a rotating body including a rotor blade;
a rotor shaft disposed in a center of the rotating body;
a magnetic bearing configured to levitate and support the rotor shaft;
a touchdown bearing that is separated, by a gap, from the rotor shaft and configured to support the rotor shaft when the magnetic bearing is uncontrollable; and
a bearing protection structure configured to protect the touchdown bearing, wherein
the bearing protection structure includes a protrusion disposed on at least one of the rotating body and a component around the rotating body, and
upon touchdown of the rotor shaft on the touchdown bearing, the rotating body comes into contact with the component around the rotating body through the protrusion so that kinetic energy of the rotating body acting on the touchdown bearing is reduced.

2. The vacuum pump according to claim 1, further comprising a stator column serving as the component around the rotating body and disposed at an inner circumference side of the rotating body and at an outer circumference side of the rotor shaft,
wherein the protrusion is disposed on at least one of an inner circumference surface of the rotating body or an outer circumference surface of the stator column.

3. The vacuum pump according to claim 2, wherein
a purge gas flow passage, through which purge gas flows, is formed between the inner circumference surface of the rotating body and the outer circumference surface of the stator column, and
the protrusion is disposed in the purge gas flow passage.

4. The vacuum pump according to claim 1, wherein
at a back side of the rotating body, a back plate is disposed as the component around the rotating body or a part of the component to prevent disturbance of exhaust gas, and
the protrusion is disposed on at least one of a back surface of the rotating body and the back plate.

5. The vacuum pump according to claim 1, wherein
a storage portion is disposed at a position downstream of the protrusion to store contaminants created on contact between the rotating body and the component around the rotating body.

6. The vacuum pump according to claim 1, wherein the protrusion is disposed to be adjacent to a downstream end of the rotating body.

7. The vacuum pump according to claim 1, wherein
the protrusion is provided in plurality, and
the plurality of protrusions are arranged at regular intervals in a circumferential direction.

8. The vacuum pump according to claim 1, wherein the protrusion has a surface that has a lower friction property than those of the rotating body and the component around the rotating body.

9. A vacuum pump bearing protection structure to be used in a vacuum pump to protect a touchdown bearing, wherein
the vacuum pump includes:
a rotating body including a rotor blade;
a rotor shaft disposed in a center of the rotating body;
a magnetic bearing that levitates and supports the rotor shaft; and
a touchdown bearing that is separated, by a gap, from the rotor shaft and supports the rotor shaft when the magnetic bearing is uncontrollable,
the bearing protection structure includes a protrusion disposed on at least one of the rotating body and a component around the rotating body, and
upon touchdown of the rotor shaft on the touchdown bearing, the rotating body comes into contact with the component around the rotating body through the protrusion so that kinetic energy of the rotating body acting on the touchdown bearing is reduced.

10. A vacuum pump rotating body to be levitated and supported by a magnetic bearing disposed in a vacuum pump, the rotating body comprising:
a rotor blade; and
a rotor shaft disposed in a center of the rotor blade, wherein
the vacuum pump includes a touchdown bearing that is separated, by a gap, from the rotor shaft and supports the rotor shaft when the magnetic bearing is uncontrollable,
the rotating body includes a bearing protection structure configured to protect the touchdown bearing, and
the bearing protection structure includes a protrusion configured to, upon touchdown of the rotor shaft on the touchdown bearing, come into contact with a component around the rotating body to reduce kinetic energy of the rotating body acting on the touchdown bearing.
